(19) United States
(12) Patent Application Publication
(10) Pub. No.: US 2006/0077754 A1
(43) Pub. Date: Apr. 13, 2006

(54) Mixing machine

(75) Inventors: Gian Marco Bressani, Hong Kong (HK); Soo Chuan Chng, Singapore (SG)

Correspondence Address: SUGHRUE MION, PLLC, 2100 PENNSYLVANIA AVENUE, N.W., SUITE 800, WASHINGTON, DC, 20037, US

(73) Assignee: STARDALE LIMITED

(21) Appl. No.: 11/245,063

(22) Filed: Oct. 7, 2005

(30) Foreign Application Priority Data
Oct. 8, 2004 (IT) TO2004A000694

(51) Int. Cl. B01F 11/00

(52) U.S. Cl. 366/209; 366/217

(57) ABSTRACT

The machine comprises a clamping structure including a pair of clamping plates which can rotate about a first axis and can be moved towards one another to clamp on the longitudinally opposite sides a container containing the product to be mixed. The clamping structure is arranged to rotate about a second axis perpendicular to the first axis, in such a manner that the container can be caused to rotate simultaneously about two perpendicular axes. An inner driving shaft controls the clamping movement of the plates, while an outer driving shaft controls the rotational movement of the container about the two perpendicular axes. A single electric motor controls the inner and outer driving shafts by means of respective belt transmissions.

### BACKGROUND OF THE INVENTION

The present invention relates to a mixing machine for mixing or amalgamating products in liquid, solid or powder form, such as in particular varnishes, paints and the like.

More particularly, the invention relates to a gyroscopic-type mixing machine, that is a mixing machine in which the mixing of the product is obtained by causing the can, drum or other container containing the product to rotate both about its own longitudinal axis (vertical direction) and about an axis perpendicular to its own axis (horizontal direction).

EP-A-0 955 081 discloses a mixing machine of the above-indicated type, comprising an inner driving shaft controlled by a first electric motor through a first belt and a first pulley and an outer driving shaft, coaxial with the first, controlled by a second electric motor through a second belt and a second pulley. The inner driving shaft controls the movement of a pair of upper and lower plates for clamping the container, while the outer driving shaft controls the rotation of both the upper clamping plate, in order to rotate the container about its own longitudinal axis, and a support structure for the two clamping plates, in order to rotate the container about an axis perpendicular to its own longitudinal axis. The operation of the machine involves a first clamping phase in which only the first electric motor is controlled in order to perform the clamping of the container between the two plates and a second mixing phase in which only the second electric motor is controlled in order to cause the container to rotate about the two perpendicular axes of rotation. The first motor is clearly without a brake, as the rotational movement of the plate-carrying structure during the above-mentioned second phase would otherwise cause a further clamping of the container between the two plates and hence the buckling or even the breakage of the container. During the mixing phase, therefore, the first pulley and the first motor do not remain stationary but are also dragged into rotation. Since during this second phase it is no more possible to exert a further clamping action on the container, if the initial clamping is not strong enough the container may come out of the plates while it is rotating.

Another drawback of this known machine is due to the use of two motors, together with the associated belts and pulleys, which requires greater attention in complying with the geometric tolerances during the assembly of the machine, in particular as regards the alignment of the belts, since possible misalignments would generate great noise and irregular wear of the parts and might cause the belts to come out of their seats. Moreover, the use of two motor requires additional electrical components and therefore involves high overall costs and considerable wear.

### SUMMARY OF THE INVENTION

It is therefore an object of the present invention to obviate to the drawbacks of the prior art discussed above.

In short, the invention is based on the idea of using a single electric motor which controls, through one or two friction clutches, the rotation of a pair of driving pulleys which in turn drive, by means of respective belts arranged in parallel, a pair of driven pulleys acting as flywheels, each of which is fixed for rotation with a respective driving shaft. Thanks to the use of a single motor the number of components, and therefore the cost of the machine, are reduced. Moreover, as will appear more clearly from the following description, the machine according to the invention ensures a secure clamping of the container during the mixing movement in any condition.

### BRIEF DESCRIPTION OF THE DRAWINGS

Further characteristics and advantages of the invention will result from the detailed description which follows, given purely by way of non limitative example with reference to the appended drawings, in which:

FIG. 1 is a side elevation, partially transparent view, which shows a whole mixing machine according to the present invention;

FIG. 2 is a perspective view of a first embodiment of the driving mechanism of the machine of FIG. 1; and

FIG. 3 is a perspective view of a second embodiment of the driving mechanism of the machine of FIG. 1.

### DESCRIPTION OF PREFERRED EMBODIMENTS

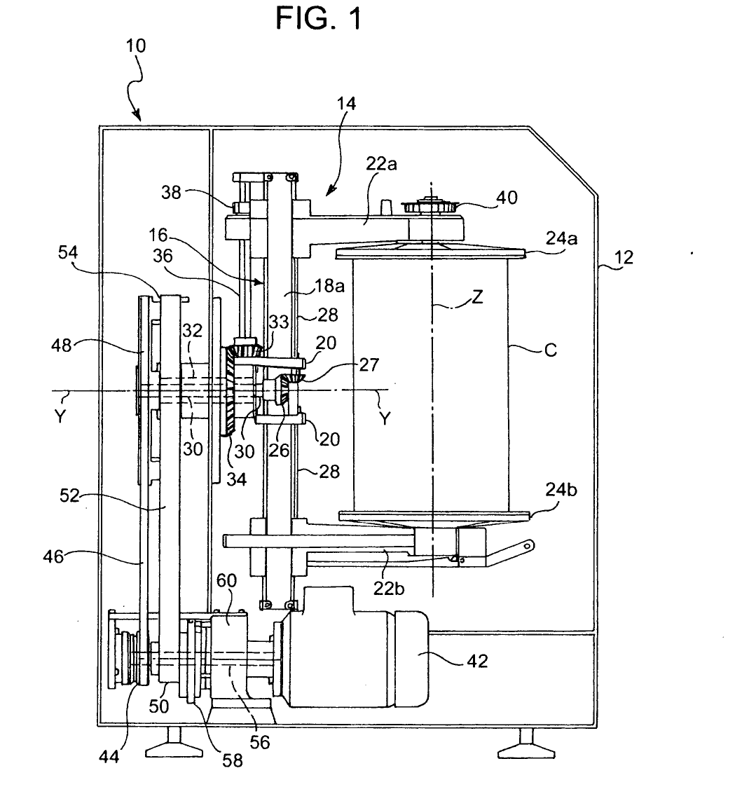

With reference first to FIG. 1, a mixing machine for mixing or amalgamating varnishes, paints, powder products, seeds and the like is generally indicated 10 and comprises a frame 12 which accommodates and supports the mechanisms arranged to clamp a container or can C containing the product to be mixed or amalgamated and to set into rotation this container or can both about the longitudinal axis Z thereof (vertical axis) and about a second axis Y perpendicular to the first one (horizontal axis).

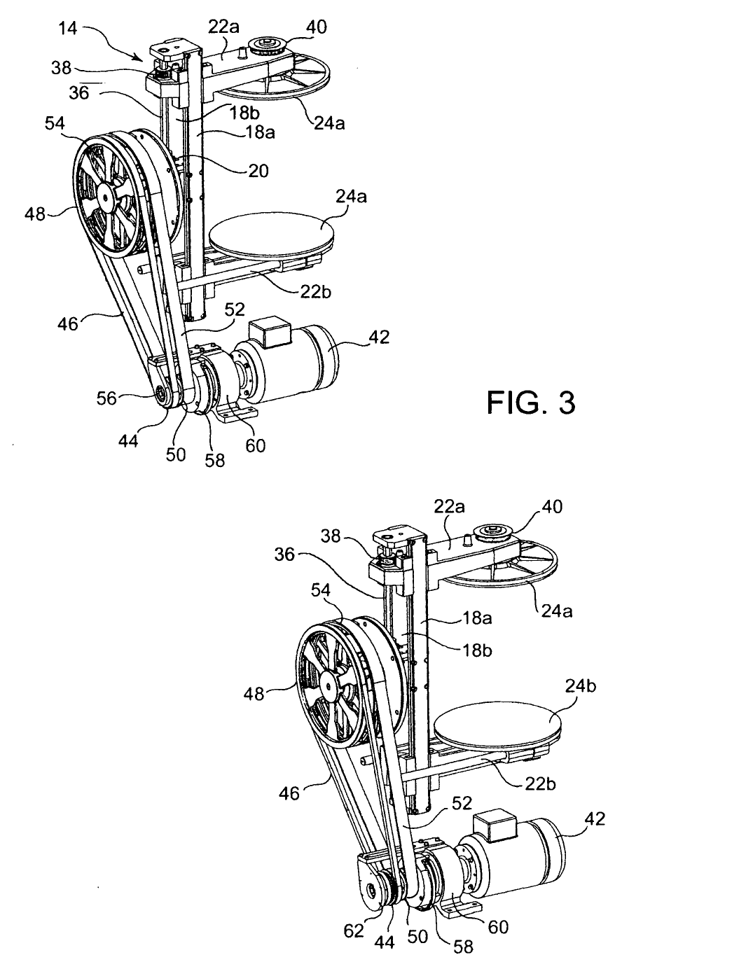

These mechanisms comprises first of all a clamping structure, generally indicated 14, supported by the frame 12 for rotation about the horizontal axis Y. The clamping structure 14 includes a turning arm 16 comprising a pair of straight guides 18a, 18b (which can be observed more clearly in FIGS. 2 and 3) arranged parallel to one another along a transverse direction with respect to the axis of rotation Y and fixed centrally to a fork-like hub 20. A pair of support members 22a, 22b carrying respective clamping plates 24a, 24b are slidably mounted on the two straight guides 18a, 18b, on the opposite sides with respect to the axis Y, to clamp the container or can C at its longitudinally opposite ends.

The two support members 22a, 22b are driven by an inner driving shaft 30 supported by the frame 12 for rotation about its own longitudinal axis, coincident with the horizontal axis of rotation Y. To this end, the inner driving shaft 30 carries at its end facing the container or can C a first bevel gear 26 meshing with a second bevel gear 27 fixed for rotation to a worm 28 (partially visible in FIG. 1) which is rotatably supported by the hub 20 and cooperates with both the support members 22a, 22b. Therefore, as the inner driving shaft 30 is caused to rotate about its own axis longitudinal Y, the two support members 22a, 22b and the two clamping plates 24a, 24b carried thereon move towards one another (clamping) or away from one another (release) depending on the direction of rotation of the inner driving shaft 20.

The two clamping plates 24a, 24b are supported by the respective support members 22a, 22b so as to be able to rotate about respective axes, coincident with the vertical axis of rotation Z. By setting into rotation either of the two clamping plates (in the illustrated example the upper plate 24a), with the container or can C clamped between the two plates, the rotational movement of the container or can C about its own longitudinal axis is achieved. This rotational movement is controlled by an outer hollow driving shaft 32 arranged coaxial with the inner driving shaft 30, the inner driving shaft 30 extending within the outer driving shaft 32. To this end, a driven pulley 40 is fixed for rotation to the clamping plate 24a and is operated through a belt (not illustrated) by a driving pulley 38 carried by a transmission shaft 36. The transmission shaft 36 is arranged parallel to the straight guides 18a, 18b and is supported by the hub 20 for rotation about its own longitudinal axis. A third bevel gear 33 is carried by the transmission shaft 36 and meshes with a fourth bevel gear 34 fixed to the frame 12 of the machine and arranged coaxial with the two driving shafts 30 and 32.

The hub 20 is fixed for rotation to the outer driving shaft 32. Accordingly, when the outer driving shaft 32 is operated, it causes the hub 20, and therefore the clamping structure 14 carrying the container or can C, to rotate about the horizontal axis of rotation Y. Moreover, due to the meshing between the third bevel gear 33, which rotates together with the hub 20 about the horizontal axis of rotation Y, and the third bevel gear 34, which on the other hand is fixed, the rotational movement of the outer driving shaft 32 is transmitted to the transmission shaft 36 and then to the pulleys 38 and 40, thus causing the container or can C to rotate about its own longitudinal axis.

An electric motor 42 controls the rotation of the outer driving shaft 32 by means of a first belt transmission comprising a first driving pulley 50, a first belt 52 and a first driven pulley 54, acting as a flywheel, which is fixed for rotation with the shaft 32. The electric motor 42 also controls the rotation of the inner driving shaft 30 by means of a second belt transmission comprising a second driving pulley 44, a second belt 46 and a second driven pulley 48, acting as a flywheel, which is fixed for rotation with the shaft 30.

FIG. 2 illustrates in greater detail a first single-clutch embodiment of the mechanism for driving the two shafts 30 and 32 of the machine 10. According to this embodiment, on a motor shaft 56 of the electric motor 42 are mounted, in addition to the two driving pulleys 44 and 50, a first clutch 58, preferably a magnetic clutch, which controls the rotational coupling of the first driving pulley 50 with the motor shaft 56, and a braking device 60 acting on the first driving pulley 50 to hold the clamping structure 14 fixed in a predetermined angular position when the mixing operation is completed. The second driving pulley 44, which controls the movement of the clamping plates 24a, 24b, is on the contrary fixed for rotation with the motor shaft 56, so as always to transmit motion to the inner driving shaft 30 in order to exert the clamping action on the container or can C. When the machine is in the rest condition, the braking device 60 is activated so as to hold the clamping structure 14 stationary, while the clutch 58 is disengaged so as to uncouple the first driving pulley 50 from rotation with the motor shaft 56.

The diameters of the two driving pulleys 44 and 50 and of the respective driven pulleys 48 and 54 are set in such a manner that the transmission ratio of the second belt transmission (pulleys 44 and 48) is slightly greater than that of the first belt transmission (pulleys 50 and 54). In this way, since the two driving pulleys 44 and 50 rotates at the same speed (speed of the motor shaft 56), the second driven pulley 48, and hence the inner driving shaft 30 which controls the clamping movement of the container or can C, rotates at a higher speed than the first driven pulley 54, and hence than the outer driving shaft 32. Accordingly, the second driven pulley 48 is no more dragged as a result of the rotation of the clamping structure 14 and of the associated driving mechanism, but is always active and therefore ensures that the two clamping plates 24a, 24b exert a clamping action which is strong enough to prevent the container or can C from being released during the mixing movement. It is however obvious that the difference in the transmission ratio should not be too great in order to avoid an increase of the clamping force during the mixing, as both the pulley transmission are simultaneously driven by the motor 42 during this phase.

A second, double-clutch embodiment of the mechanism for driving the two driving shafts 30 and 32 of the machine 10 is illustrated in greater detail in FIG. 3, in which parts and elements identical to those of FIG. 2 are indicated by the same reference numerals. According to this embodiment, in addition to the first clutch 58 associated to the first driving pulley 50 a second clutch 62, preferably a magnetic clutch, is provided which controls the rotational coupling of the second driving pulley 44 with the motor shaft 56. This second clutch 62 is normally disengaged and is engaged in order to connect the second driving pulley 44 for rotation with the motor shaft 56 and therefore to control the clamping movement of the container or can C only when the first clutch 58 is disengaged, that is in the rest condition of the machine. Once the two clamping plates 24a, 24b have clamped the container or can C, the second clutch 62 is deactivated and therefore the associated second pulley 44 is uncoupled from the motor shaft 56. At this point, the braking device 60 which prevent the rotation of the clamping structure 14 is deactivated and the first clutch 58 is engaged to perform the mixing movement. Upon completion of the mixing, the first clutch 58 is disengaged and the braking device 60 is reactivated. In order to release the container or can C, the second clutch 62 is engaged and the electric motor 42 is operated in the opposite direction.

The use of two clutches does not limit the difference in the transmission ratios of the two belt transmissions which transmit the motion from the two driving pulleys 44 and 50 to the associated driven pulleys 48 and 54. In this case also, the second driven pulley 48 has a smaller diameter than the first driven pulley 54 so as to prevent the container or can C from being released from the clamping plates 24a, 24b during the mixing.

Naturally, the principle of the invention remaining unchanged, embodiments and manufacturing details may vary widely from those described and illustrated purely by way of non-limiting example.

What is claimed is:

1. A mixing machine for mixing or amalgamating products in liquid, solid or powder form, such as in particular varnishes, paints and the like, comprising
a clamping structure including a pair of clamping plates mounted for rotation about a first axis and for translation towards one another to clamp on the longitudinally opposite sides a container containing the product to be mixed, said clamping structure being rotatable about a second axis perpendicular to the first axis, in such a manner that the container can be set into rotation simultaneously about two perpendicular axes;
a first driving shaft controlling the rotational movement of the container about said first and second axes;
a second driving shaft controlling the translational movement of the clamping plates;
a first belt transmission including a first driving pulley;
a second belt transmission including a second driving pulley;
a single motor,
a motor shaft controlled by the motor and carrying said first and second driving pulleys, and
a first clutch operable to couple said first driving pulley for rotation with the motor shaft.

2. The mixing machine of claim 1, further including a braking device operable to brake said first driving pulley.

3. The mixing machine of claim 1, wherein said second driving pulley is fixed for rotation to the motor shaft.

4. The mixing machine of claim 1, further including a second clutch operable to couple said second driving pulley for rotation with the motor shaft.

5. The mixing machine of claim 1, wherein said first clutch is a magnetic clutch.
